(19) United States
(12) Patent Application Publication
(10) Pub. No.: US 2026/0222885 A1
(43) Pub. Date: Jul. 30, 2026

(54) PROCESSING METHOD FOR MEASUREMENT, AND COMMUNICATION DEVICE

(71) Applicant: GUANGDONG OPPO MOBILE TELECOMMUNICATIONS CORP., LTD., Dongguan (CN)

(72) Inventors: Rongyi HU, Dongguan (CN); Jinyu ZHANG, Dongguan (CN)

(21) Appl. No.: 19/573,884

(22) Filed: Mar. 20, 2026

Related U.S. Application Data
(63) Continuation of application No. PCT/CN2023/135970, filed on Dec. 1, 2023.

(51) Int. Cl. H04W 24/10; H04W 8/24

(52) U.S. Cl. CPC H04W 24/10; H04W 8/24

(57) ABSTRACT

A processing method and a communication device are provided. The method is performed by a terminal device and the method includes: reporting capability information to a network device, wherein the capability information is used to indicate that the terminal device supports a pre-configured network-controlled small gap (pre-NCSG). The communication device includes a processor; a memory storing one or more computer programs; and a transceiver; wherein the one or more computer programs, when run by the processor, cause the communication device to: receive capability information reported by a terminal device, wherein the capability information is used to indicate that the terminal device supports a pre-NCSG; and configure the pre-NCSG for the terminal device based on the capability information.

### CROSS-REFERENCE TO RELATED APPLICATION

This application is a continuation of International Application No. PCT/CN2023/135970, filed Dec. 1, 2023, the entire disclosure of which is incorporated herein by reference.

### TECHNICAL FIELD

The present disclosure relates to the field of mobile communication technology, and in particular, relates to a processing method for measurement, and a communication device.

### RELATED ART

To reduce the interruption time caused by user equipment (UE) measurement(s), a network-controlled small gap (NCSG) has been introduced into the communication protocol.

In related technologies, an NCSG may be configured by a network device to a terminal device, enabling the terminal device to perform measurement(s) using an idle radio frequency (RF) chain.

### SUMMARY

Embodiments of the present disclosure provide a processing method for measurement, and a communication device. The technical solutions are as follows:

According to some embodiments of the present disclosure, a processing method for measurement is provided. The method is performed by a terminal device and includes: reporting capability information to a network device, wherein the capability information is used to indicate that the terminal device supports a pre-configured NCSG (pre-NCSG).

According to some embodiments of the present disclosure, a communication device is provided. The communication device includes a processor, a memory, and a transceiver. The memory stores one or more computer programs, wherein the one or more computer programs, when run by the processor, cause the communication device to: receive capability information reported by a terminal device, wherein the capability information is used to indicate that the terminal device supports a pre-NCSG; and configure the pre-NCSG for the terminal device based on the capability information.

According to some embodiments of the present disclosure, a communication device is provided. The communication device includes a processor, a memory, and a transceiver. The memory stores one or more computer programs, wherein the one or more computer programs, when run by the processor, cause the communication device to report capability information to a network device, wherein the capability information is used to indicate that the communication device supports a pre-NCSG.

### BRIEF DESCRIPTION OF DRAWINGS

FIG. 1 is a schematic diagram of the architecture of a communication system according to some embodiments of the present disclosure;

FIG. 2 is a schematic diagram of a measurement gap (MG) and an NCSG in a synchronous scenario involved in the present disclosure;

FIG. 3 is a schematic diagram of an MG and an NCSG in an asynchronous scenario involved in the present disclosure;

FIG. 4 is a schematic diagram of NCSG configuration parameters involved in the present disclosure;

FIG. 5 is a flowchart of a processing method for measurement according to some embodiments of the present disclosure;

FIG. 6 is a flowchart of a processing method for measurement according to some embodiments of the present disclosure;

FIG. 7 is a flowchart of a processing method for measurement according to some embodiments of the present disclosure;

FIG. 8 is a block diagram of a processing apparatus for measurement according to some embodiments of the present disclosure;

FIG. 9 is a block diagram of a processing apparatus for measurement according to some embodiments of the present disclosure; and

FIG. 10 is a structural schematic diagram of a communication device according to some embodiments of the present disclosure.

### DETAILED DESCRIPTION

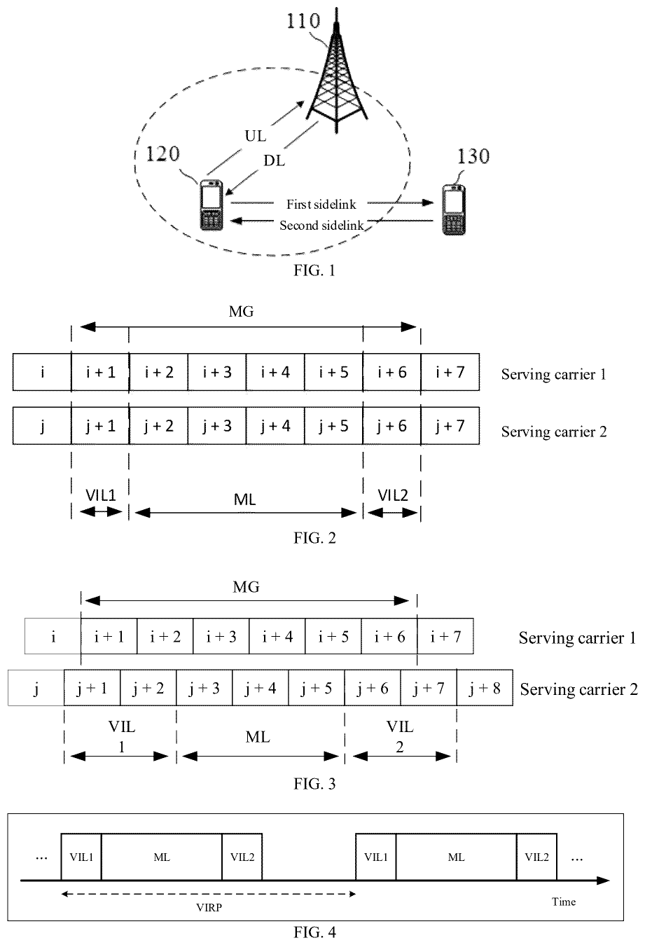

FIG. 1 is a schematic diagram of a communication system involved in some exemplary embodiments of the present disclosure. The communication system includes a network device 110 and a terminal device 120, and/or includes a terminal device 120 and a terminal device 130, which is not limited in the present disclosure.

The network device 110 according to the present disclosure provides wireless communication functionality. The network device 110 includes but is not limited to: an evolved Node-B (eNB), a radio network controller (RNC), a Node-B (NB), a base station controller (BSC), a base transceiver station (BTS), a home base station (e.g., a home evolved Node-B or a home Node-B (HNB)), a baseband unit (BBU), an access point (AP) in a wireless fidelity (Wi-Fi) system, a wireless relay node, a wireless backhaul node, a transmission point (TP) or a transmission and reception point (TRP), or the like. The network device 110 may also be a next generation Node-B (gNB) or a transmission point (TRP or TP) in a 5th generation (5G) mobile communication system, one antenna panel or a group of (including a plurality of antenna panels) antenna panels of a base station in the 5G system, a network node constituting a gNB or a transmission point, such as a BBU or a distributed unit (DU), or a base station in a beyond-fifth generation (B5G) or 6th generation (6G) mobile communication system, or the like. The network device 110 may refer to a core network (CN), fronthaul, backhaul, a radio access network (RAN), a network slice, or the like; or a serving cell, a primary cell (PCell), a primary secondary cell (PSCell), a special cell (SpCell), a secondary cell (SCell), or a neighboring cell of the terminal device, or the like.

At least one of the terminal device 120 or the terminal device 130 in the present disclosure is also referred to as a UE, an access terminal, a subscriber unit, a subscriber station, a mobile station, a remote station, a remote terminal, a mobile device, a user terminal, a terminal, a wireless communication device, a user agent, or a user device. The terminal device includes but is not limited to: a handheld device, a wearable device, a vehicle-mounted device, and an Internet of things (IoT) device, such as a mobile phone, a tablet computer, an e-book reader, a laptop computer, a desktop computer, a TV, a game console, a mobile Internet device (MID), an augmented reality (AR) terminal, a virtual reality (VR) terminal, a mixed reality (MR) terminal, a wearable device, a handle, an electronic tag, a controller, a wireless terminal in industrial control, a wireless terminal in self-driving, a wireless terminal in remote medical technology, a wireless terminal in smart grid, a wireless terminal in transportation safety, a wireless terminal in smart city, a wireless terminal in smart home, a wireless terminal in remote medical surgery, a cellular phone, a cordless phone, a Session Initiation Protocol (SIP) phone, a wireless local loop (WLL) station, a personal digital assistant (PDA), a set-top box (STB), or a customer premise equipment (CPE), or the like.

The network device 110 and the terminal device 120 communicate with each other via an air interface technology, such as a Uu interface.

Exemplarily, two communication scenarios are present between the network device 110 and the terminal device 120, namely, an uplink communication scenario and a downlink communication scenario. The uplink communication refers to transmitting signals to the network device 110. The downlink communication refers to transmitting signals to the terminal device 120.

The terminal device 120 and the terminal device 130 communicate with each other via an air interface technology, such as a PC5 interface.

In some embodiments, two communication scenarios are present between the terminal device 120 and the terminal device 130, namely, a first sidelink communication scenario and a second sidelink communication scenario. The first sidelink communication refers to transmitting signals to the terminal device 130. The second sidelink communication refers to transmitting signals to the terminal device 120.

Both the terminal device 120 and the terminal device 130 are within the network coverage and located in the same cell, or both the terminal device 120 and the terminal device 130 are within the network coverage but located in different cells, or the terminal device 120 is within the network coverage but the terminal device 130 is outside the network coverage.

The technical solutions according to the embodiments of the present disclosure is applicable to various communication systems, such as a global system of mobile communication (GSM) system, a code-division multiple access (CDMA) system, a wideband code-division multiple access (WCDMA) system, a general packet radio service (GPRS), a long-term evolution (LTE) system, an LTE frequency-division duplex (FDD) system, an LTE time-division duplex (TDD) system, an advanced long-term evolution (LTE-A) system, a universal mobile telecommunication system (UMTS), a worldwide interoperability for microwave access (WiMAX) communication system, a 5G mobile communication system, a new radio (NR) system, an evolved system of the NR system, an LTE-based access to unlicensed spectrum (LTE-U) system, an NR-based access to unlicensed spectrum (NR-U) system, a terrestrial network (TN) system, a non-terrestrial network (NTN) system, a wireless local area network (WLAN), a Wi-Fi system, a cellular IoT system, or a cellular passive IoT system. The technical solutions according to the embodiments of the present disclosure may also be applied to an evolved system of the 5G NR system, as well as B5G, 6G, and subsequent evolved systems. In some embodiments of the present disclosure, “NR” may also be referred to as a 5G NR system or a 5G system. The 5G mobile communication system may include non-standalone (NSA) and/or standalone (SA).

The technical solutions according to the embodiments of the present disclosure may also be applied to a machine-type communication (MTC), a long term evolution-machine (LTE-M) technology, a device-to-device (D2D) network, a machine-to-machine (M2M) network, an IoT network, or other networks. The IoT network may include, for example, an Internet of vehicles (IoV). Communication methods in an IoV system are collectively referred to as vehicle-to-X (i.e., V2X, where X represents any object). For example, the V2X may include vehicle-to-vehicle (V2V) communications, vehicle-to-infrastructure (V2I) communications, vehicle-to-pedestrian (V2P) communications, or vehicle-to-network (V2N) communications.

### 1) NCSG

The concept of NCSG originated from the LTE Release-14 (R-14), with the primary objective of reducing interruption time caused by UE measurement(s). In a case where an NCSG is activated, a UE may perform measurement(s) using an idle RF chain. This case requires only a relatively short interruption time (for RF chain adjustment) during measurement, eliminating the need for a longer MG. For instance, an MG typically requires an interruption lasting six subframes. However, the use of the NCSG introduces only brief interruptions at the beginning and end, i.e., during a VIL1 and a VIL2, wherein the VIL1 refers to a visible interruption length before measurement, and the VIL2 refers to a visible interruption length after measurement, and during a measurement length (ML), measurements and data transmission/reception with a serving cell may be maintained simultaneously. This effectively reduces data interruption time while ensuring measurement performance. Clearly, whether the UE supports an NCSG is based on a capability of the UE, such as whether the UE has idle RF resources. The UE needs to report to a network side whether the UE possesses NCSG capabilities, such that the network determines how to configure corresponding MG(s), NCSG(s), or the like.

The LTE protocol defines four NCSG patterns as listed in Table 1 below, as specified in 36.133. NCSG #0 and NCSG #2 are based on MG pattern #0 and are applicable to synchronous and asynchronous scenarios, respectively. NCSG #1 and NCSG #3 are based on MG pattern #1, where a visible interruption repetition period (VIRP) of the NSCG is equal to a measurement gap repetition period (MGRP) of the MG, and a sum of a VIL1, an ML, and a VIL2 (i.e., VIL1+ML+VIL2) of the NSCG is equal to a measurement gap length (MGL) of the MG. NCSG #1 and NCSG #3 are applicable to synchronous and asynchronous scenarios, respectively. Please refer to FIG. 2 and FIG. 3, where FIG. 2 is a schematic diagram of an MG and an NCSG in the synchronous scenario involved in the present disclosure, and FIG. 3 is a schematic diagram of an MG and an NCSG in the asynchronous scenario involved in the present disclosure.

TABLE 1

| NCSG | | ML during | | | |
|---|---|---|---|---|---|
| Pattern | VIL1 | which there is | VIL2 | VIRP | |
| Id | (ms) | no gap (ms) | (ms) | (ms) | Purpose |
| 0 | 1 | 4 | downlink | 40 | Interruption control |
| | | | (DL): 1 | | according to |
| | | | uplink | | requirements in |
| | | | (UL): | | sections x, y, x |
| | | | 2 | | |
| 1 | 1 | 4 | DL: 1 | 80 | Interruption control |
| | | | UL: 2 | | according to |
| | | | | | requirements in |
| | | | | | sections x, y, x |
| 2 | 2 | 3 | 2 | 40 | Interruption control |
| | | | | | according to |
| | | | | | requirements in |
| | | | | | sections x, y, x |
| 3 | 2 | 3 | 2 | 80 | Interruption control |
| | | | | | according to |
| | | | | | requirements in |
| | | | | | sections x, y, x |

As listed in Table 2 below, capability reporting information of the UE includes ‘nscg-r14,’ which indicates whether NCSG pattern #0 to NCSG pattern #3 are supported. For both an LTE UE and an NR UE, MG pattern #0 and MG pattern #1 are mandatory to be supported.

TABLE 2

| | |
|---|---|
| MeasParameters-v1430 ::= SEQUENCE { | |
| ceMeasurements-r14 | ENUMERATED {supported} |
| OPTIONAL, | |
| ncsg-r14 | ENUMERATED {supported} |
| OPTIONAL, | |
| shortMeasurementGap-r14 | ENUMERATED {supported} |
| OPTIONAL, | |
| perServingCellMeasurementGap-r14 | ENUMERATED {supported} |
| OPTIONAL, | |
| non UniformGap-r14 | ENUMERATED {supported} |
| OPTIONAL | |
| } | |

The field ’ncsg' indicates whether the UE supports NCSG Pattern Id 0, 1, 2 and 3 for measurement,
as specified in TS 36.133 [16]. In a case where this field is included and the UE supports asynchronous
dual connectivity (DC), the UE shall support NCSG Pattern Id 0, 1, 2 and 3. In a case where this field is
included but the UE does not support asynchronous DC, only NCSG Pattern Id 0 and 1 shall be
supported.

The UE indicates to the network side, on a per-component carrier (CC) basis, whether an MG or an NCSG is required for measurement on a corresponding CC, signaling for which in 36.133 is listed in Table 3 below. In this table, ‘gapIndication-r14’ has three enumeration values, wherein ‘gap’ indicates that the UE requires a gap for measurement on the corresponding carrier, ‘ncsg’ indicates that an NCSG configuration is required, and ‘nogap-noNcsg’ indicates that neither the gap for measurement nor the NCSG configuration is required.

TABLE 3
PerCC-GapIndication information elements,
[36.331, UE → NW]
-- ASNISTART
PerCC-GapIndicationList-r14 :: = SEQUENCE (SIZE
(1 . . . maxServCell-r13)) OF PerCC-GapIndication-r14
PerCC-GapIndication-r14 :: = SEQUENCE {
servCellId-r14 ServCellIndex-r13,
gapIndication-r14 ENUMERATED
{gap, ncsg, nogap-noNcsg}
-- ASNISTOP

Currently, an NR NCSG has been introduced in MG measurement enhancement in NR R-17.

The UE shall support NCSG patterns that are relevant to the UE's measurement capabilities. The ML refers to a measurement length. During the VIL1 and the VIL2, the UE is not expected to transmit and receive any data, wherein the VIL1 is a visible interruption length before the ML and the VIL2 is a visible interruption length after the ML. During the ML, whether the UE is expected to transmit and receive data on corresponding serving carrier(s) depends on scheduling restriction requirements specified in clauses 9.2.7.3 and 9.3.10.3.

The NCSG configuration parameters VIL1, ML, VIL2, and VIRP are illustrated in FIG. 4, which is a schematic diagram of the involved NCSG configuration parameters. NCSG configurations supported by the UE are listed in Table 4 below.

TABLE 4

| NCSG Pattern Id | ML (ms) | VIRP (ms) |
|---|---|---|
| 0 | 5 | 40 |
| 1 | 5 | 80 |
| 2 | 2 | 40 |
| 3 | 2 | 80 |
| 4 | 5 | 20 |
| 5 | 5 | 160 |
| 6 | 3 | 20 |
| 7 | 3 | 40 |
| 8 | 3 | 80 |
| 9 | 3 | 160 |
| 10 | 2 | 20 |
| 11 | 2 | 160 |
| 12 | 5 | 20 |
| 13 | 5 | 40 |
| 14 | 5 | 80 |
| 15 | 5 | 160 |
| 16 | 3 | 20 |
| 17 | 3 | 40 |
| 18 | 3 | 80 |
| 19 | 3 | 160 |
| 20 | 1 | 20 |
| 21 | 1 | 40 |
| 22 | 1 | 80 |
| 23 | 1 | 160 |

For the VIL1 or the VIL2 in a per-UE NCSG configuration or a per-frequency range 1 (FR1) NCSG configuration, the VIL is equal to 1 ms. For the VIL1 or the VIL2 in a per-frequency range 2 (FR2) NCSG configuration, the VIL is equal to 0.75 ms.

### 2) Pre-Configured MG (Pre-MG)

Any of measurement gap pattern #0 to measurement gap pattern #25 may be configured as a pre-MG pattern. The UE may determine a pre-MG status based on an autonomous activation/deactivation mechanism or based on a network-controlled activation/deactivation mechanism.

The measurement gap patterns may be as listed in Table 5 below.

TABLE 5

| Gap | MGL | MGRP | | | |
|---|---|---|---|---|---|
| Pattern Id | (ms) | (ms) | Gap Pattern Id | MGL | MGRP |
| 0 | 6 | 40 | 13 | 5.5 | 40 |
| 1 | 6 | 80 | 14 | 5.5 | 80 |
| 2 | 3 | 40 | 15 | 5.5 | 160 |
| 3 | 3 | 80 | 16 | 3.5 | 20 |
| 4 | 6 | 20 | 17 | 3.5 | 40 |
| 5 | 6 | 160 | 18 | 3.5 | 80 |
| 6 | 4 | 20 | 19 | 3.5 | 160 |
| 7 | 4 | 40 | 20 | 1.5 | 20 |
| 8 | 4 | 80 | 21 | 1.5 | 40 |
| 9 | 4 | 160 | 22 | 1.5 | 80 |
| 10 | 3 | 20 | 23 | 1.5 | 160 |
| 11 | 3 | 160 | 24 | 10 | 80 |
| 12 | 5.5 | 20 | 25 | 20 | 160 |

The pre-MG has two activation/deactivation modes, namely an autonomous activation/deactivation mode and a network-controlled activation/deactivation mode.

The UE shall also autonomously determine the pre-MG status based on all concurrent triggering conditions occurring jointly:
downlink control information (DCI), timer or radio resource control (RRC) based active bandwidth part (BWP) switching;
activation/deactivation of SCell(s);
addition/removal of any measurement object(s);
addition/release/change of an SCell in carrier aggregation.

In a case where the network provides the activation/deactivation status via an RRC indication ‘preConfGapStatus’ for all DL BWPs of all activated CCs and for all deactivated secondary CCs (SCCs), a UE capable of both autonomous and network-controlled mechanisms for activation/deactivation of a pre-MG pattern may not use autonomous rules to determine an activation/deactivation status of a pre-MG.

That is, the UE may not adopt the autonomous mode for pre-MG activation/deactivation in a case where the UE supports both network-controlled and autonomous modes.

### 3) MG and MG Sharing Mechanism

To enable the UE to perform measurement(s) more effectively, the network may configure a specific time window, known as the measurement gap (i.e., MG). Table 5 above illustrates MG pattern #0 to MG pattern #23 supported in the Rel-15, wherein considering the longer repetition period (or burst duration) of PRS signals, the Rel-16 introduces two new MG patterns, namely MG pattern #24 and MG pattern #25.

In a case where the network configures the UE to simultaneously perform measurements on both intra-frequency and inter-frequency points within a single MG, the UE needs to coordinate time allocation for different measurement objects within the MG, which is known as an MG sharing mechanism. An MG sharing scheme for an NR version primarily follows an MG sharing scheme defined in an LTE version (reflected in a carrier-specific scaling factor (CSSF)), summarized as follows (see Chapter 9.1.5.2 of the Protocol 38.133 for details):
in a case where a measurement object refers to a long-periodicity measurement which is any of an evolved universal terrestrial radio access (E-UTRA) reference signal time difference (RSTD) measurement or an NR positioning reference signal (PRS) measurement, CSSF_{within_gap,i}=1. This indicates that the long-periodicity PRS measurement does not need to share the MG with other measurements and has a higher measurement priority;
in a case where a measurement object refers to a short-periodicity measurement which is any of a PRS positioning measurement or another synchronization signal block (SSB)/channel state information reference signal (CSI-RS) measurement, mutual competition for an MG is required. The final CSSF_{with_gap,i} is determined by counting, within each MG, the quantity M_{intra,i,j} of intra-frequency measurement objects, the quantity M_{inter,i,j} of inter-frequency measurement objects, and the total quanitity M_{tot,i,j} of measurement objects, and combining a parameter ‘measGapSharingScheme’ and a ratio Ri of available MGs excluding those used for long-periodicity measurements, wherein M_{tot,i,j}=M_{intra,i,j}+M_{inter,i,j}, and PRS measurements belong to inter-frequency measurements.

In a case where the ‘measGapSharingScheme’ indicates an equal sharing scheme, CSSF_{within gap,i}=max(ceil(Ri×M_{tot,i,j})), where j=0 . . . (160/MGRP)−1;

In a case where the ‘measGapSharingScheme’ indicates an unequal sharing scheme, the CSSF_{with_gap,i} is determined based on a value of Kᵢₙₜᵣₐ or Kᵢₙₜₑᵣ which is determined based on indication:
in a case where a measurement object i is an intra-frequency measurement object, the CSSF_{with_gap,i} is the maximum among:

$$ceil ( {R}_{i} \times {K}_{intra} \times {M}_{intra , i , j} ) in gaps , wherein$$

$${M}_{inter , i , j} \neq 0 , and j = 0 … ( 160 / MGRP ) - 1 ;$$

$$ceil ( {R}_{i} \times {M}_{intra , i , j} ) in gaps , wherein$$

$${M}_{inter , i , j} = 0 , and j = 0 … ( 160 / MGRP ) - 1.$$

in a case where the measurement object i is an inter-frequency measurement object, the CSSF_{with_gap,i} is the maximum among:

$$ceil ( {R}_{i} \times {K}_{inter} \times {M}_{inter , i , j} ) in gaps , wherein$$

$${M}_{intra , i , j} \neq 0 , and j = 0 … ( 160 / MGRP ) - 1 ;$$

$$ceil ( {R}_{i} \times {M}_{inter , i , j} ) in gaps , wherein$$

$${M}_{intra , i , j} = 0 , and j = 0 … ( 160 / MGRP ) - 1.$$

Rᵢ represents a maximal ratio of the quantity of MGs in which the measurement object i is a candidate to be measured, to the quantity of MGs in which the measurement object i is a candidate to be measured and which are not used for a long-periodicity PRS measurement. This is described in the protocol as: “Ri is the maximal ratio of the number of measurement gap where measurement object i is a candidate to be measured over the number of measurement gaps where the measurement object i is a candidate and not used for RSTD measurement with periodicity Tprs >160 ms or with periodicity Tprs=160 ms but prs-MutingInfo-r9 is configured within an arbitrary 1280 ms period.”

Currently, the NR lacks UE capabilities and network configuration methods for pre-NCSGs, as well as activation/deactivation methods for pre-NCSGs. Specifically:
1) No capability information is provided regarding whether the UE supports pre-NCSGs and for supported NCSG activation methods.
2) No indication (e.g., ‘pre-configInd’) is provided for enabling a pre-NCSG configuration on the network side. Currently, network-side information may only indicate whether a UE is allowed to use a pre-MG or an NCSG. However, no information is provided for the enabling of the pre-NCSG.

FIG. 5 is a flowchart of a processing method for measurement according to some embodiments of the present disclosure. The method may be performed by a terminal device. The terminal device may be the terminal device 120 or the terminal device 130 in the network architecture illustrated in FIG. 1. The method may include the following steps.

In step 510, the terminal device reports capability information to a network device, wherein the capability information is used to indicate that the terminal device supports a pre-NCSG.

In some embodiments, the capability information includes one or more of:
first indication information, used to indicate the terminal device has a capability to support a pre-NCSG;
second indication information, used to indicate whether the terminal device supports a pre-configured NCSG pattern and/or which pre-configurable NCSG pattern is supported by the terminal device;
third indication information, used to indicate that the terminal device supports network-controlled pre-NCSG activation/deactivation; or
fourth indication information, used to indicate that the terminal device supports autonomous pre-NCSG activation/deactivation.

In some embodiments, reporting the capability information to the network device includes one of:
reporting the capability information on a per-device basis in a measurement or mobility configuration;
reporting the capability information on a per-band basis; or
reporting the capability information on a per-cell basis.

In some embodiments, the method further includes:
receiving first signaling from the network device in a case where the terminal device supports simultaneous configuration or use of an NCSG and a pre-MG during a measurement process; wherein the first signaling is used to instruct the terminal device to simultaneously configure or use the NCSG and the pre-MG during the measurement process.

In some embodiments, the method further includes:
receiving second signaling from the network device, the second signaling being used to indicate that a first parameter and a second parameter are both true;
wherein the first parameter is used to indicate whether an MG is a pre-MG, and the second parameter is used to indicate whether an MG is an NCSG.

In some embodiments, the method further includes:
activating or deactivating an NCSG via network control in a case where one or more network-controlled RRC indications for all DL BWPs of all activated CCs and for all deactivated SCCs are configured for the terminal device by the network device.

In some embodiments, activating or deactivating the NCSG via network control includes:
receiving control information from the network device; and
activating or deactivating the NCSG based on the control information.

In some embodiments, the control information includes one or more of:
a message used in an RRC configuration or reconfiguration for configuration/addition/removal/change of a measurement object, for configuration/update of an MG, for addition/removal of a carrier, or for activation/deactivation;
a BWP switching message triggered by a timer, DCI, or an RRC message;
medium access control (MAC)-control element (CE) activation/deactivation signaling dedicated to a pre-NCSG; or
a message used in an RRC configuration or reconfiguration for configuring an NCSG.

In some embodiments, a condition for the terminal device to support the autonomous pre-NCSG activation/deactivation includes one or more of:
a pre-NCSG activation/deactivation process corresponds to an active BWP switching process based on DCI, a timer, or RRC;
a pre-NCSG activation/deactivation process corresponds to an activation/deactivation process of an SCell;
a pre-NCSG activation/deactivation process corresponds to an addition/removal process of a measurement object;
a pre-NCSG activation/deactivation process corresponds to an addition, release, or change process of an SCell in carrier aggregation;
the terminal device supports switching between deactivation and activation of an NCSG;
the terminal device supports a change between indicating ‘nogap-noncsg’ and indicating ‘nogap-withncsg’ in a NeedForGapNCSG report; or
the terminal device supports a change in a NeedForInterruptionReport.

In summary, according to the embodiments of the present disclosure, the terminal device may report its capabilities of supporting a pre-NCSG to the network device, such that the network device may subsequently configure the pre-NCSG for the terminal device, thereby improving the accuracy of pre-NCSG configuration by the network device and enhancing the communication efficiency of the network.

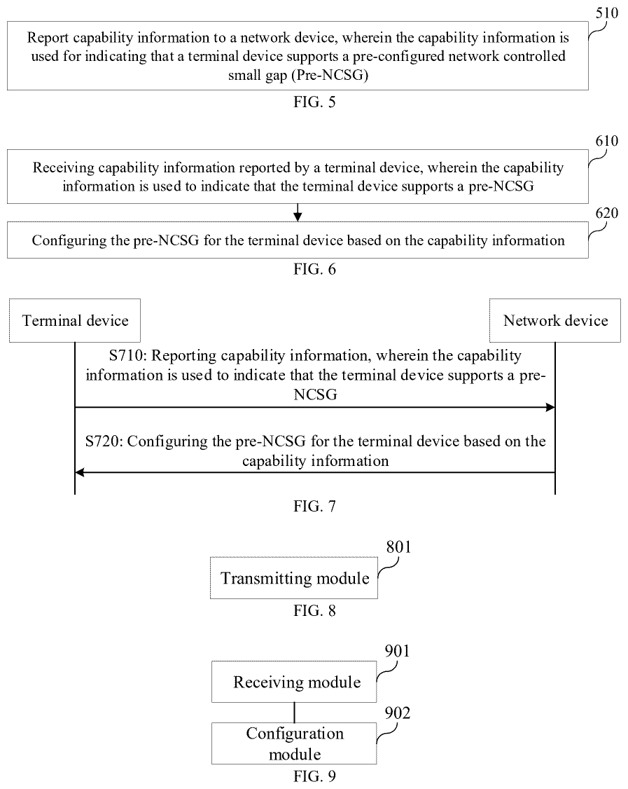

FIG. 6 is a flowchart of a processing method for measurement according to some embodiments of the present disclosure. This method may be performed by a network device. The network device may be the network device 110 in the network architecture illustrated in FIG. 1. The method may include the following steps.

In step 610, the network device receives capability information reported by a terminal device, wherein the capability information is used to indicate that the terminal device supports a pre-NCSG.

In step 620, the network device configures the pre-NCSG for the terminal device based on the capability information.

In summary, according to the embodiments of the present disclosure, the network device may receive the capabilities of the terminal device to support a pre-NCSG that are reported by the terminal device. Subsequently, the network device may configure the pre-NCSG for the terminal device, thereby improving the accuracy of pre-NCSG configuration by the network device and enhancing the communication efficiency of the network.

FIG. 7 is a flowchart of a processing method for measurement according to some embodiments of the present disclosure. This method may be performed via interaction between a terminal device and a network device. The terminal device may be the terminal device 120 or terminal device 130 in the network architecture illustrated in FIG. 1, and the network device may be the network device 110 in the network architecture illustrated in FIG. 1. This method may include the following steps.

In step 710, the terminal device reports capability information to the network device, and correspondingly, the network device receives the capability information reported by the terminal device. This capability information is used to indicate that the terminal device supports a pre-NCSG.

In some embodiments, the capability information includes one or more of:
first indication information, used to indicate that the terminal device has a capability to support the pre-NCSG;
second indication information, used to indicate whether the terminal device supports a pre-configured NCSG pattern and/or which pre-configurable NCSG pattern is supported by the terminal device;
third indication information, used to indicate that the terminal device supports network-controlled pre-NCSG activation/deactivation; or
fourth indication information, used to indicate that the terminal device supports autonomous pre-NCSG activation/deactivation.

In the embodiments of the present disclosure, a method for indicating the capability information may be as follows:

1) Explicit indication. For example, a capability of a UE to support a pre-NCSG is indicated, or which NCSG pattern(s) can be pre-configured are indicated.

2) Implicit indication via support for NCSG activation modes. This involves adding, in measandmobparameter, an indicator for supporting network-controlled pre-NCSG activation/deactivation, and/or, an indicator for supporting UE-autonomous pre-NCSG activation/deactivation.

In some embodiments, reporting the capability information to the network device includes:
reporting the capability information on a per-device basis in a measurement or mobility configuration;
reporting the capability information on a per-band basis; or reporting the capability information on a per-cell basis.

In the embodiment of the present disclosure, the above reporting modes for the capability information may be as follows:
1) per-UE reporting in a measurement or mobility configuration (e.g., within a measandmob container); or
2) per-band/per-cell reporting, similar to an indication (NCSG) in needforNCSG, such as reporting together with ‘ServCellIndex’ or ‘FreqBandIndicatorNR.’ and a corresponding gapindication.

In step 720, the network device configures the pre-NCSG for the terminal device based on the capability information.

In some embodiments, in a case where the terminal device supports simultaneous configuration or use of an NCSG and a pre-MG during a measurement process, the network device transmits first signaling to the terminal device. Correspondingly, in a case where the terminal device supports simultaneous configuration or use of an NCSG and a pre-MG during a measurement process, the terminal device receives the first signaling that is transmitted by the network device. The first signaling is used to instruct the terminal device to simultaneously configure or use the NCSG and the pre-MG during the measurement process.

In a case where the capability information of the terminal device indicates that the terminal device supports the simultaneous configuration or use of the NCSG and the pre-MG during the measurement process, the network device may explicitly indicate, via an addition of new signaling, that an NCSG and a pre-MG in an MG configuration of the UE are allowed to be used simultaneously. The signaling may be as follows:

preConfigInd-r17
ENUMERATED {true}
OPTIONAL,
-- Need R
ncsgInd-r17
ENUMERATED
{true}
OPTIONAL.
-- Need R
PreNCSGind
ENUMERATED {true}
gap AssociationPRS-r17
ENUMERATED {true}
OPTIONAL,
-- Need R
gapSharing-r17
MeasGapSharingScheme
OPTIONAL,
-- Need R
gapPriority-r17
GapPriority-r17
OPTIONAL,
-- Need R

In some embodiments, in a case where the terminal device supports the simultaneous configuration or use of the NCSG and the pre-MG during the measurement process, the network device transmits second signaling to the terminal device. Correspondingly, the terminal device receives the second signaling that is transmitted by the network device. The second signaling is used to indicate that a first parameter and a second parameter are both true. The first parameter is used to indicate whether an MG is a pre-MG, and the second parameter is used to indicate whether an MG is an NCSG.

In the embodiments of the present disclosure, the description of existing signaling (e.g., in Release-17) may also be modified to allow an indication that ‘preConfigInd’ and ‘ncsgInd’ are both set to ‘true.’

The ‘preConfigInd’ indicates whether an MG is a pre-MG. The ‘ncsgInd’ indicates that an MG is an NCSG as specified in 38.133.

In the embodiments of the present disclosure, the terminal device may support network-controlled pre-NCSG activation/deactivation, and/or the terminal device may support autonomous pre-NCSG activation/deactivation.

The network device may select to activate or deactivate an NCSG via network control based on the pre-NCSG activation/deactivation modes supported by the terminal device.

In some embodiments, in a case where a network-controlled RRC indication is configured for the terminal device for all DL BWPs of all activated CCs and for all deactivated SCCs, the network device controls the terminal device to activate or deactivate an NCSG.

Correspondingly, in a case where one or more network-controlled RRC indications for all DL BWPs of all activated CCs and for all deactivated SCCs are configured for the terminal device by the network device, the terminal device activates or deactivates an NCSG via network control.

A UE may report capabilities of supporting both autonomous and network-controlled activation/deactivation modes. The specific mode to be used depends on a configuration of a network. In a case where the UE supports the two activation/deactivation modes, and where one or more network-controlled RRC indications for all DL BWPs of all activated CCs, and for all deactivated SCCs are configured by the network, the UE adopts the network-controlled NCSG activation/deactivation mode.

In some embodiments, in a case where the network device controls the terminal device to activate or deactivate an NCSG, the network device may transmit control information to the terminal device. The control information is used by the terminal device to activate or deactivate the NCSG.

Correspondingly, in a case where the terminal device activates or deactivates an NCSG via network control, the terminal device may receive control information that is transmitted by the network device, and activate or deactivate the NCSG based on the control information.

Specifically, a network-controlled activation/deactivation indication may be 1-bit information specially configured via RRC; or may be activated (e.g., via ‘withNCSG’) or deactivated (e.g., via ‘noNCSG’) based on a change in an indication of needforgNCSG.

In some embodiments, the control information includes one or more of:
a message used in an RRC configuration or reconfiguration for configuration/addition/removal/change of a measurement object, for configuration/update of an MG, for addition/removal of a carrier, or for activation/deactivation;
a BWP switching message triggered by a timer, DCI, or an RRC message;
MAC-CE activation/deactivation signaling dedicated to a pre-NCSG; or
a message used in an RRC configuration or reconfiguration for configuring an NCSG.

In some embodiments, a condition for the terminal device to support the autonomous pre-NCSG activation/deactivation includes one or more of:
a pre-NCSG activation/deactivation process corresponds to an active BWP switching process based on DCI, a timer, or RRC;
a pre-NCSG activation/deactivation process corresponds to an activation/deactivation process of an SCell;
a pre-NCSG activation/deactivation process corresponds to an addition/removal process of a measurement object;
a pre-NCSG activation/deactivation process corresponds to an addition, release, or change process of an SCell in carrier aggregation;
the terminal device supports switching between deactivation and activation of an NCSG;
the terminal device supports a change between indicating ‘nogap-noncsg’ and indicating ‘nogap-withncsg’ in a NeedForGapNCSG report; or
the terminal device supports a change in a NeedForInterruptionReport.

A condition for the autonomous activation/deactivation by the terminal device may include at least one of the following item 1) to item 7).
1) Active BWP switching based on DCI, a timer, or RRC.
2) Activation/deactivation of SCell(s).
3) Addition/removal of any measurement object(s).
4) Addition/release/change of an SCell in carrier aggregation.
5) The UE supports the switching between ‘nogap-nointerruption’ (for NCSG deactivation) and ‘nogap-withinterruption’ (for NCSG activation) indicated in ‘NeedForGap-InfoNR-R18.’

The Rel-18 indication is in addition to the ledacy NeedForGapsInfoNR information. The UE may report three different cases:
in a case where a gap is required, the UE reports “gap” in an Rel-16 field and reports an empty field in a corresponding R18 information element (IE);
in a case where no gap is required and there is no interruption, the UE reports “no gap” in the Rel-16 field and “no-gap-no-interruption” in an Rel-18 field; and
in a case where no gap is required but there is an interruption, the UE reports “no-gap” in the Rel-16 field and “no-gap-with-interruption” in the Rel-18 field.
6) The UE supports eutra-NeedForGapNCSG-reporting-r17, indicating changes between indicating ‘nogap-noncsg’ in the E-UTRA band in NeedForGapNCSG-InfoEUTRA for inter-RAT EUTRA measurements and indicating ‘nogap-withncsg’ in the E-UTRA band in NeedForGapNCSG-InfoEUTRA for inter-RAT EUTRA measurements.
7) The UE supports changes in a NeedForInterruptionReport.

The protocol introduces a new indication (‘needForInterruptionInfoNR’) for the Rel-18 case, wherein interruption is required for NR SSB based on measurement without gap. The Rel-18 indication may be included in RRCReconfigurationComplete and RRCResumeComplete messages. RAN4 agreed to support measurements without gap with interruption for NR SSB-based inter-frequency and intra-frequency. The UE includes the Rel-18 indication (needForInterruptionInfoNR) in a case where the network requests it via a controlling flag (needForInterruptionConfigNR).

The solutions according to the embodiments of the present disclosure clarify the configuration for pre-NCSG and UE capabilities, facilitating the flexible utilization of the NCSG by networks and terminals to mitigate the impact of measurement on throughput.

FIG. 8 is a block diagram of a processing apparatus for measurement according to some embodiments of the present disclosure. This processing apparatus for measurement has functions, performed by a terminal device, for implementing the method illustrated in any of FIGS. 5 to 7. As illustrated in FIG. 8, the apparatus may include a transmitting module 801, configured to report capability information to a network device, wherein the capability information is used to indicate that the terminal device supports a pre-NCSG.

In some embodiments, the capability information includes one or more of: first indication information, used to indicate that the terminal device has a capability to support the pre-NCSG; second indication information, used to indicate whether the terminal device supports a pre-configured NCSG pattern and/or which pre-configurable NCSG pattern is supported by the terminal device; third indication information, used to indicate that the terminal device supports network-controlled pre-NCSG activation/deactivation; or fourth indication information, used to indicate that the terminal device supports autonomous pre-NCSG activation/deactivation.

In some embodiments, the transmitting module 801 is configured to: report the capability information on a per-device basis in a measurement or mobility configuration; report the capability information on a per-band basis; or report the capability information on a per-cell basis.

In some embodiments, the apparatus further includes: a first receiving module, configured to receive first signaling from the network device in a case where the terminal device supports simultaneous configuration or use of an NCSG and a pre-MG during a measurement process; wherein the first signaling is used to instruct the terminal device to simultaneously configure or use the NCSG and the pre-MG during the measurement process.

In some embodiments, the apparatus further includes: a second receiving module, configured to receive second signaling from the network device in a case where the terminal device supports simultaneous configuration or use of an NCSG and a pre-MG during a measurement process, wherein the second signaling is used to indicate that a first parameter and a second parameter are both true; wherein the first parameter is used to indicate whether an MG is the pre-MG, and the second parameter is used to indicate whether the MG is the NCSG.

In some embodiments, the apparatus further includes: an activation module, configured to activate or deactivate an NCSG via network control, in a case where one or more network-controlled RRC indications for all DL BWPs of all activated CCs and for all deactivated SCCs are configured for the terminal device by the network device.

In some embodiments, the activation module is configured to: receive control information from the network device; and activate or deactivate the NCSG based on the control information.

In some embodiments, the control information includes one or more of: a message used in an RRC configuration or reconfiguration for configuration/addition/removal/change of a measurement object, for configuration/update of an MG, for addition/removal of a carrier, or for activation/deactivation; a BWP switching message triggered by a timer, DCI, or an RRC message; MAC-CE activation/deactivation signaling dedicated to the pre-NCSG; or a message used in an RRC configuration or reconfiguration for configuring the NCSG.

In some embodiments, a condition for the terminal device to support autonomous pre-NCSG activation/deactivation includes one or more of: a pre-NCSG activation/deactivation process corresponds to an active BWP switching process based on DCI, a timer, or RRC; a pre-NCSG activation/deactivation process corresponds to an activation/deactivation process of an SCell; a pre-NCSG activation/deactivation process corresponds to an addition/removal process of a measurement object; a pre-NCSG activation/deactivation process corresponds to an addition, release, or change process of an SCell in carrier aggregation; the terminal device supports switching between deactivation and activation of an NCSG; the terminal device supports a change between indicating ‘nogap-noncsg’ and indicating ‘nogap-withncsg’ in a NeedForGapNCSG report; or the terminal device supports a change in a NeedForInterruptionReport.

FIG. 9 is a block diagram of a processing apparatus for measurement according to some embodiments of the present disclosure. This processing apparatus for measurement has functions, performed by a network device, for implementing the method illustrated in any of FIGS. 5 to 7. As illustrated in FIG. 9, the apparatus may include: a receiving module 901, configured to receive capability information reported by a terminal device, wherein the capability information is used to indicate that the terminal device supports a pre-NCSG; and a configuration module 902, configured to configure the pre-NCSG for the terminal device based on the capability information.

In some embodiments, the capability information includes one or more of: first indication information, used to indicate that the terminal device has a capability to support the pre-NCSG; second indication information, used to indicate whether the terminal device supports a pre-configured NCSG pattern and/or which pre-configurable NCSG pattern is supported by the terminal device; third indication information, used to indicate that the terminal device supports network-controlled pre-NCSG activation/deactivation; or fourth indication information, used to indicate that the terminal device supports autonomous pre-NCSG activation/deactivation.

In some embodiments, the receiving module 901 is configured to: receive the capability information, wherein the capability information is reported by the terminal device on a per-device basis in a measurement or mobility configuration; receive the capability information, wherein the capability information is reported by the terminal device on a per-band basis; or receive the capability information, wherein the capability information is reported by the terminal device on a per-cell basis.

In some embodiments, the configuration module 902 is configured to transmit first signaling to the terminal device in a case where the terminal device supports simultaneous configuration or use of an NCSG and a pre-MG during a measurement process; wherein the first signaling is used to instruct the terminal device to simultaneously configure or use the NCSG and the pre-MG during the measurement process.

In some embodiments, the configuration module 902 is configured to transmit second signaling to the terminal device in a case where the terminal device supports simultaneous configuration or use of an NCSG and a pre-MG during a measurement process, wherein the second signaling is used to indicate that a first parameter and a second parameter are both true; wherein the first parameter is used to indicate whether an MG is the pre-MG, and the second parameter is used to indicate whether the MG is the NCSG.

In some embodiments, the apparatus further includes: a control activation module, configured to control the terminal device to activate or deactivate an NCSG, in a case where one or more network-controlled RRC indications are configured for the terminal device for DL BWPs of all activated CCs and for all deactivated SCCs.

In some embodiments, the control activation module is configured to transmit control information to the terminal device, wherein the control information is used for the terminal device to activate or deactivate the NCSG.

In some embodiments, the control information includes one or more of: a message used in an RRC configuration or reconfiguration for configuration/addition/removal/change of a measurement object, for configuration/update of an MG, for addition/removal of a carrier, or for activation/deactivation; a BWP switching message triggered by a timer, DCI, or an RRC message; MAC-CE activation/deactivation signaling dedicated to the pre-NCSG; or a message used in an RRC configuration or reconfiguration for configuring the NCSG.

In some embodiments, a condition for the terminal device to support autonomous pre-NCSG activation/deactivation includes one or more of: a pre-NCSG activation/deactivation process corresponds to an active BWP switching process based on DCI, a timer, or RRC; a pre-NCSG activation/deactivation process corresponds to an activation/deactivation process of an SCell; a pre-NCSG activation/deactivation process corresponds to an addition/removal process of a measurement object; a pre-NCSG activation/deactivation process corresponds to an addition, release, or change process of an SCell in carrier aggregation; the terminal device supports switching between deactivation and activation of an NCSG; the terminal device supports a change between indicating ‘nogap-noncsg’ and indicating ‘nogap-withncsg’ in a NeedForGapNCSG report; or the terminal device supports a change in a NeedForInterruptionReport.

It should be noted that, in implementing functions, the apparatus provided in the above embodiments is only described by way of example based on the division of the above functional modules. In practical applications, the above functions may be allocated to and accomplished by different functional modules as needed. That is, the internal structure of the apparatus may be divided into different functional modules to perform all or part of the functions described above.

The specific ways in which each module in the apparatus of the above embodiments performs operations are described in detail in the embodiments related to the method, and are not elaborated herein.

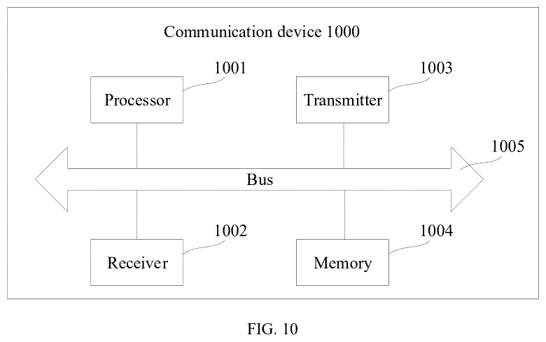

FIG. 10 is a structural schematic diagram of a communication device 1000 according to some embodiments of the present disclosure. The communication device 1000 may include: a processor 1001, a receiver 1002, a transmitter 1003, a memory 1004, and a bus 1005.

The processor 1001 includes one or more processing cores. The processor 1001 executes various functional applications and performs information processing by running software programs and modules.

The receiver 1002 and the transmitter 1003 may be implemented as a single communication component, which may be a communication chip. This communication chip may also be referred to as a transceiver. The memory 1004 is communicably connected to the processor 1001 via the bus 1005. The memory 1004 may be configured to store one or more computer programs. The one or more computer programs, when run by the processor 1001, cause the processor 1001 to perform the steps in the above method embodiments.

In addition, the memory 1004 may be implemented by any type of a volatile or non-volatile storage device or a combination thereof. The volatile or non-volatile storage device includes, but is not limited to: a magnetic or optical disk, an electrically-erasable programmable read-only memory (EEPROM), an erasable programmable read-only memory (EPROM), a static random-access memory (SRAM), a read-only memory (ROM), a magnetic memory, a flash memory, and a programmable ROM (PROM).

In an exemplary embodiment, in a case where the communication device 1000 is implemented as the aforementioned terminal device, the one or more computer programs, when run by the receiver 1002 and processor 1001, cause the communication device to perform the steps performed by the terminal device in the method as illustrated in any of FIGS. 5 to 7.

In an exemplary embodiment, in a case where the communication device 1000 is implemented as the aforementioned network device, the one or more computer programs, when run by the transmitter 1003 and processor 1001, cause the communication device to perform the steps performed by the network device in the method as illustrated in any of FIGS. 5 to 7.

The embodiments of the present disclosure also provide a computer-readable storage medium, in which one or more computer programs are stored. The one or more computer programs, when loaded and run by a processor, cause the processor to perform all or part of the steps performed by the terminal device or the network device in the method as illustrated in any of FIGS. 5 to 7.

The present disclosure also provides a chip. The chip includes an integrated circuit and firmware stored in the integrated circuit. The chip is configured to, when running in a communication device, cause the communication device to perform all or part of the steps performed by the terminal device or the network device in the method as illustrated in any of FIGS. 5 to 7 described above.

The present disclosure also provides a computer program product. The computer program product or a computer program includes one or more computer instructions stored in a computer-readable storage medium. The one or more computer instructions, when read from the computer-readable storage medium and executed by a processor of a communication device, cause the communication device to perform all or part of the steps performed by the terminal device or the network device in the method as illustrated in any of FIGS. 5 to 7.

The present disclosure further provides a computer program. The computer program, when run by a processor of a communication device, causes the processor to perform all or part of the steps performed by the terminal device or the network device in the method as illustrated in any of FIGS. 5 to 7.

Those skilled in the art should be aware that, in one or more of the aforementioned examples, the functions described in the embodiments of the present disclosure may be implemented using hardware, software, firmware, or any combination thereof. The functions, when implemented using software, may be stored in a computer-readable medium or transmitted as one or more instructions or codes on the computer-readable medium. The computer-readable medium includes a computer storage medium and a communication medium, where the communication medium includes any medium that facilitates the transfer of a computer program from one place to another. The storage medium may be any available medium that is accessible by a general-purpose or special-purpose computer.

Described above are merely optional embodiments of the present disclosure and are not intended to limit the present disclosure. Any modifications, equivalent substitutions, improvements, or the like, made within the spirit and principle of the present disclosure shall fall within the protection scope of the present disclosure.

1. A processing method for measurement, performed by a terminal device, the method comprising:
reporting capability information to a network device, wherein the capability information is used to indicate that the terminal device supports a pre-configured network-controlled small gap (pre-NCSG).

2. The method according to claim 1, wherein the capability information comprises at least one of:
first indication information, used to indicate that the terminal device has a capability to support the pre-NCSG;
second indication information, used to indicate whether the terminal device supports a pre-configured NCSG pattern and/or which pre-configurable NCSG pattern is supported by the terminal device;
third indication information, used to indicate that the terminal device supports network-controlled pre-NCSG activation/deactivation; or
fourth indication information, used to indicate that the terminal device supports autonomous pre-NCSG activation/deactivation.

3. The method according to claim 1, wherein reporting the capability information to the network device comprises:
reporting the capability information on a per-device basis in a measurement or mobility configuration;
reporting the capability information on a per-band basis; or
reporting the capability information on a per-cell basis.

4. The method according to claim 1, further comprising:
receiving first signaling from the network device in a case where the terminal device supports simultaneous configuration or use of an NCSG and a pre-configured measurement gap (pre-MG) during a measurement process;
wherein the first signaling is used to instruct the terminal device to simultaneously configure or use the NCSG and the pre-MG during the measurement process.

5. The method of claim 1, further comprising:
receiving second signaling from the network device in a case where the terminal device supports simultaneous configuration or use of an NCSG and a pre-configured measurement gap (pre-MG) during a measurement process, wherein the second signaling is used to indicate that a first parameter and a second parameter are both true;
wherein the first parameter is used to indicate whether an MG is the pre-MG, and the second parameter is used to indicate whether the MG is the NCSG.

6. The method according to claim 1, further comprising:
activating or deactivating an NCSG via network control in a case where one or more network-controlled radio resource control (RRC) indications for all downlink (DL) bandwidth parts (BWPs) of all activated component carriers (CCs) and for all deactivated secondary CCs (SCCs) are configured for the terminal device by the network device.

7. The method according to claim 6, wherein activating or deactivating the NCSG via network control comprises:
receiving control information from the network device; and
activating or deactivating the NCSG based on the control information.

8. The method according to claim 7, wherein the control information comprises at least one of:
a message used in an RRC configuration or reconfiguration for configuration/addition/removal/change of a measurement object, for configuration/update of a measurement gap (MG), for addition/removal of a carrier, or for activation/deactivation;
a BWP switching message triggered by a timer, downlink control information (DCI), or an RRC message;
medium access control (MAC)-control element (CE) activation/deactivation signaling dedicated to the pre-NCSG; or
a message used in an RRC configuration or reconfiguration for configuring the NCSG.

9. The method according to claim 1, wherein a condition for the terminal device to support autonomous pre-NCSG activation/deactivation comprises at least one of:
a pre-NCSG activation/deactivation process corresponds to an active bandwidth part (BWP) switching process based on downlink control information (DCI), a timer, or radio resource control (RRC);
a pre-NCSG activation/deactivation process corresponds to an activation/deactivation process of a secondary cell (SCell);
a pre-NCSG activation/deactivation process corresponds to an addition/removal process of a measurement object;
a pre-NCSG activation/deactivation process corresponds to an addition, release, or change process of an SCell in carrier aggregation;
the terminal device supports switching between deactivation and activation of an NCSG;
the terminal device supports a change between indicating ‘nogap-noncsg’ and indicating ‘nogap-withncsg’ in a NeedForGapNCSG report; or
the terminal device supports a change in a NeedForInterruptionReport.

10. A communication device, comprising:
a processor;
a memory storing one or more computer programs; and
a transceiver;
wherein the one or more computer programs, when run by the processor, cause the communication device to:
receive capability information reported by a terminal device, wherein the capability information is used to indicate that the terminal device supports a pre-configured network-controlled small gap (pre-NCSG); and
configure the pre-NCSG for the terminal device based on the capability information.

11. The communication device according to claim 10, wherein the capability information comprises at least one of:
first indication information, used to indicate that the terminal device has a capability to support the pre-NCSG;
second indication information, used to indicate whether the terminal device supports a pre-configured NCSG pattern and/or which pre-configurable NCSG pattern is supported by the terminal device;
third indication information, used to indicate that the terminal device supports network-controlled pre-NCSG activation/deactivation; or
fourth indication information, used to indicate that the terminal device supports autonomous pre-NCSG activation/deactivation.

12. The communication device according to claim 10, wherein the one or more computer programs, when run by the processor, further cause the communication device to:
receive the capability information, wherein the capability information is reported by the terminal device on a per-device basis in a measurement or mobility configuration; or
receive the capability information, wherein the capability information is reported by the terminal device on a per-band basis; or
receive the capability information, wherein the capability information is reported by the terminal device on a per-cell basis.

13. The communication device according to claim 10, wherein the one or more computer programs, when run by the processor, further cause the communication device to:
transmit first signaling to the terminal device in a case where the terminal device supports simultaneous configuration or use of an NCSG and a pre-configured measurement gap (pre-MG) during a measurement process;
wherein the first signaling is used to instruct the terminal device to simultaneously configure or use the NCSG and the pre-MG during the measurement process.

14. The communication device according to claim 10, wherein the one or more computer programs, when run by the processor, further cause the communication device to:
transmit second signaling to the terminal device in a case where the terminal device supports simultaneous configuration or use of an NCSG and a pre-configured measurement gap (pre-MG) during a measurement process, wherein the second signaling is used to indicate that a first parameter and a second parameter are both true;
wherein the first parameter is used to indicate whether an MG is the pre-MG, and the second parameter is used to indicate whether the MG is the NCSG.

15. The communication device according to claim 10, wherein the one or more computer programs, when run by the processor, further cause the communication device to:
control the terminal device to activate or deactivate an NCSG, in a case where one or more network-controlled radio resource control (RRC) indications are configured for the terminal device for all downlink (DL) bandwidth parts (BWPs) of all activated component carriers (CCs) and for all deactivated secondary CCs (SCCs).

16. The communication device according to claim 15, wherein the one or more computer programs, when run by the processor, further cause the communication device to:
transmit control information to the terminal device, wherein the control information is used for the terminal device to activate or deactivate the NCSG.

17. The communication device according to claim 16, wherein the control information comprises at least one of:
a message used in an RRC configuration or reconfiguration for configuration/addition/removal/change of a measurement object, for configuration/update of a measurement gap (MG), for addition/removal of a carrier, or for activation/deactivation;
a BWP switching message triggered by a timer, downlink control information (DCI), or an RRC message;
medium access control (MAC)-control element (CE) activation/deactivation signaling dedicated to the pre-NCSG; or
a message used in an RRC configuration or reconfiguration for configuring the NCSG.

18. The communication device according to claim 10, wherein a condition for the terminal device to support autonomous pre-NCSG activation/deactivation comprises at least one of:
a pre-NCSG activation/deactivation process corresponds to an active bandwidth part (BWP) switching process based on downlink control information (DCI), a timer, or radio resource control (RRC);
a pre-NCSG activation/deactivation process corresponds to an activation/deactivation process of a secondary cell (SCell);
a pre-NCSG activation/deactivation process corresponds to an addition/removal process of a measurement object;
a pre-NCSG activation/deactivation process corresponds to an addition, release, or change process of an SCell in carrier aggregation;
the terminal device supports switching between deactivation and activation of an NCSG;
the terminal device supports a change between indicating ‘nogap-noncsg’ and indicating ‘nogap-withncsg’ in a NeedForGapNCSG report; or
the terminal device supports a change in a NeedForInterruptionReport.

19. A communication device, comprising:
a processor;
a memory storing one or more computer programs; and
a transceiver;
wherein the one or more computer programs, when run by the processor, cause the communication device to:
report capability information to a network device, wherein the capability information is used to indicate that the communication device supports a pre-configured network-controlled small gap (pre-NCSG).
